(19) United States
(12) Patent Application Publication
(10) Pub. No.: US 2015/0334926 A1
(43) Pub. Date: Nov. 26, 2015

(54) PLANTATION INSTALLATION

(71) Applicant: GREEN STUDIOS SAL, Beirut (LB)

(72) Inventors: Jamil Charles-Roger Corbani, Studio City, CA (US); Rawan Abraham Zarour, Studio City, CA (US); Karim Charles-Roger Corbani, Baabdat (LB); Marc Abi Haila, Antelias (LB); Oliver Jean Wehbe, Keserwan (LB); Zeina Oussama Kronfol, Beirut (LB)

(21) Appl. No.: 14/284,692

(22) Filed: May 22, 2014

(51) Int. Cl. A01G 9/02

(52) U.S. Cl. CPC A01G 9/022

(57) ABSTRACT

A green or living wall is formed on the external architectural surface. The wall includes a waterproof layer to protect the surface from water and other materials from the living wall, and several plant support components extending horizontally in parallel to each other across the wall. The components include a tubular wall filled with a growth media formed of hydromix and/or potting substrate, one or more layers of a water retaining material and an out support layer. Plants are planted on the plant support components with their plants being imbedded into the growth media. The architectural surface may be oriented vertically, horizontally, or at an angle, and filler material may be used to shape the plant support components into various three-dimensional shapes.

### RELATED APPLICATIONS

None

### BACKGROUND OF THE INVENTION

A. Field of Invention

This invention pertains to an installation supporting and feeding various plants on a generally vertical wall. The installation includes a prefabricated tubular component extending horizontally and holding a growth media suitable for the respective plants.

B. Description of the Prior Art

It has been recently recognized in the field of architecture and design that vertical thermal and acoustic gardens or “green” or “living” walls provide many esthetic and functional advantages. For example, a vertical garden attached to the exterior wall of a commercial or residential building provides very effective thermal and acoustic insulation all year round. The exterior of the wall may be easier to maintain as well. Esthetically, a vertical garden can be configured with many different varieties of plants and flowers to provide virtually an infinite number of color patterns and textures for the wall, all year round.

A problem with existing vertical plantation installations for creating these gardens are difficult to make using mass-produced modular components because each wall has unique configurations and requirements. Accordingly, until now vertical plantation installations required a lot of time to plan and complete. Moreover, because each installation had to be designed individually, these installations were very expensive. In addition, mass-produced modular components allow limited volume of media for plats root stock to expand and are more sensitive and less efficient in hot weather conditions. Another ypical known installation of this type is non-modular and includes two layers of a thin mat stapled to a rigid PVC foam board. The PVC foam board was then fixed on wood, or steel structure secured to a vertical wall. In addition to the disadvantages noted above, this structure was further limited to vertical installations and was not used for other kind of plantations such as roof gardens.

### SUMMARY OF THE INVENTION

Briefly, a plantation installation for forming a living wall on an external architectural member having generally a flat outer surface is presented, the planting installation including a water proof layer attached to the outer surface; and a plant support structure disposed outwardly of the architectural member and the water proof layer. The plant support structure includes a tubular component made of a first water retaining material and defining a tubular inner space. A growth media is disposed in the tubular inner space, the growth media including materials selected to provide water and nourishment to plants. A first protective layer is disposed outside and around the tubular component, the first protective layer being made of a second water retentive material. A second protective layer is disposed around the first protective layer to hold the whole assembly together.

In one embodiment, the growth media includes a hydromix, a potting substrate or a mixture of hydromix and potting mix or substrate. The plantation installation includes a plurality of plants and preferably the growth media is selected to provide appropriate water and nutrient specific to the plurality of plants.

Optionally, the installation includes another layer disposed between said water proof layer and the plant support structure, this another layer being made of a water retaining material.

A water pipe extending horizontally above said plant support structure, said water pipe being arranged to provide water to said plant support structure.

Some layers of said plant support structure extend over and cover said water pipe.

The installation can be installed vertically horizontally or along an angled plane. Moreover, a filler can be installed under the layer to shape the layers into free-form or geometric shapes that are extremely pleasing esthetically.

Preferably a plurality of tubular components are provided on an architectural structure, each component being filled with the growth media. Once the installation is complete, slits may be made in the tubular components and layers overlaying the tubular media, and the roots of the plants can be pushed through the slits into the growth media.

### BRIEF DESCRIPTION OF THE DRAWINGS

FIG. 1 shows an exploded side view of a vertical plantation installation constructed in accordance with this invention;

FIG. 2 shows the plantation installation of FIG. 1 assembled;

FIG. 3 shows a side view of a horizontal plantation installation; and

FIG. 4 shows an exploded side view of another embodiment of the invention utilizing a filler component to provide the plantation installation a three-dimensional contour or shape.

### DETAILED DESCRIPTION OF THE INVENTION

A detailed description of a novel plantation installation is now provided that includes a composite layer having a sectional profile arranged and constructed to hold a media or substrate selected and designed for a particular installation, climate, plants to be used, etc. This composite layer is termed herein a 3 dimensional hydroponic skin. In the following description, the 3D hydroponic skin is described in conjunction with a vertical plantation installation, however, advantageously; it may be incorporated into other types of installation, such as roof gardens, urban and landscaping sculptures, lighting installations, outdoor furniture, etc.

The hydroponic skin was conceived primarily for dry, hot weather installations to counterbalance global warming, especially in dense hot cities where the heat factor is increased by asphalt, glass and traffic pollution It also allows for hot weather plant species to live and release oxygen to the cities and decrease CO₂ emission. The hydroponic skin is designed so that it can retain an optimum amount of water per area, as well as the proper amount or volume of substrate or other medium, required for relatively large plants and even trees. However, the inventors have found that the skin could also be used for other types of climates as well.

Moreover, it is envisioned that the hydroponic skin may be created and formed into various shapes and sizes using 3D printing techniques.

The hydroponic skin is further designed to reduce the production of CO₂ and accordingly reduce the carbon footprint of a building or other architectural complex. Finally, the skin can further be shaped to accommodate or create habitats for living organisms such as bird and bee nests, etc.

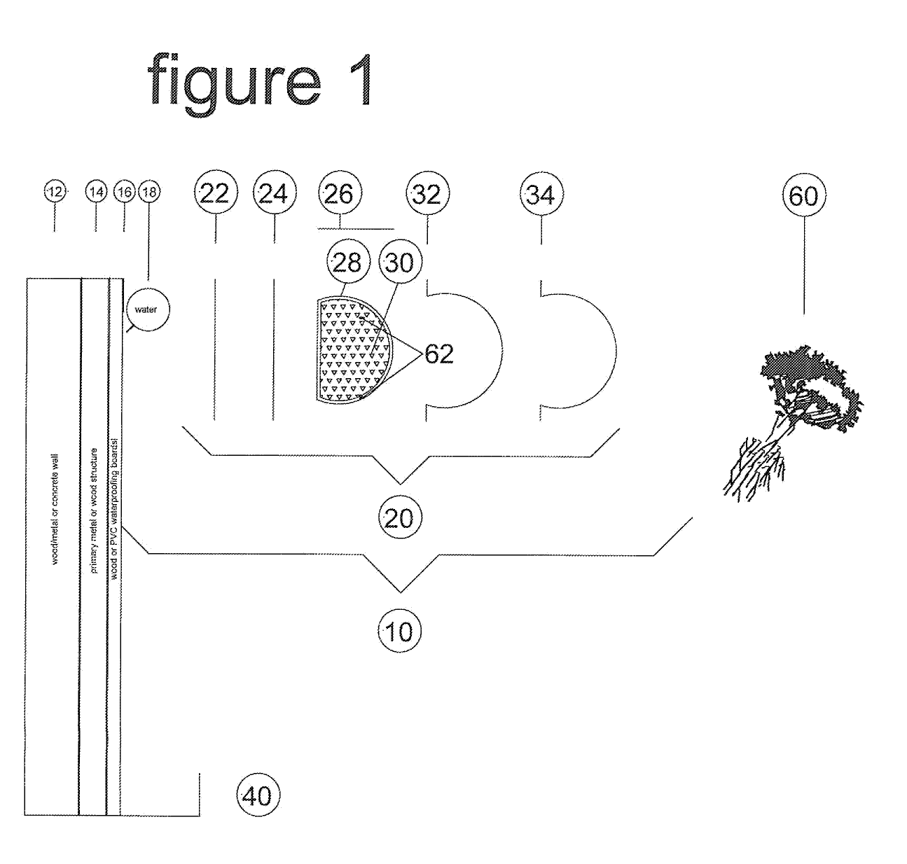

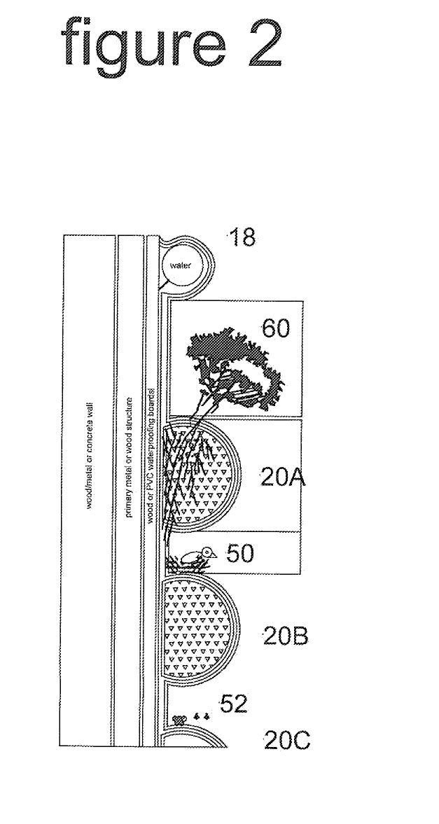

FIGS. 1 and 2 show a vertical plantation installation 10 constructed in accordance with this invention. Customarily, such an installation is supported by and on a vertical wall including an external member 12 made of steel and/or concrete or wood and is typically a load-bearing member. Attached to member 12 is an external primary member 14 made of wood or metal. Member 12 is protected from the elements (and, in this case, from possible leakage from the installation 10) by a waterproofing barrier 16 made of PVC, etc.

The plantation installation 10 includes a water source (such as a horizontal water pipe connected to water reservoir) 18 and a hydroponic skin 20.

The hydroponic skin 20 includes several components:

The first component is an inner layer 22. This layer is preferably made of a synthetic mesh-like net with 0.5 cm×0.5 cm square holes, about 1.5 mm thick and having a weight of 75 grams/per square meter. The layer 22 is preferably treated so that it resists rot and acts as a root supporting system.

The second layer 24 is made of biologically neutral, non rotting, recycled synthetic polyester or polypropylene fibers, resistant to mechanical stress, preferable strength class 3. The layer 24 can be made of natural or synthetic material such as a textile (e.g., a woven, knit, or batten material) preferably 7 mm thick and weighing 650 grs/square meter. This layer 24 may be made from recycled materials and include a polypropylene with a fleece carrier having a high water retention (e.g.,1.25 liter of water/square meter). The layer 24 acts as a roots support layer that not only supports the roots of the plants but also insures that the plants receive moisture as well as some nutrients.

Component 26 includes a tubular member 28 filled with a growth medium 30. The tubular member 28 is preferably made of a textile material, including a recycled material (cotton, wool, acrylic, linen, etc). The member 28 must be relatively light but strong enough to hold the growth medium 30 securely for an extended period of time, as well as a plurality of plants having roots imbedded therein. Typically the member 28 may be 5 mm thick and made from a material that does not expand and is also constructed so that it absorbs and retains water. The component 28 has a density of 900 grams/sq meter and water retention capacity of 3.1 liters/square meter. The component 28 can have various shapes. In FIGS. 1 and 2 it has a generally cylindrical or truncated cylindrical shape with a diameter of about 4 inches. In general, the component 26 may range from 3-6 in diameter or cross-sectional dimension.

The fourth component 32 is a mat made of a textile material (cotton, wool, acrylic, linen) reinforced from inside by a synthetic mat having a high water retention and supporting the root and growth medium within the component 26. Typically the component 32 is UV resistant and is 5 mm thick and has a weight of 850 grams/square meter, and has a water capacity of 2.15 liters/square meter, The layer holds all previous layers of skin together.

The fifth component 34 is preferably made of a synthetic mesh like net with 0.5 cm×0.5 cm square holes, about 1.5 mm thick and having a weight of 75 grams/per square meter. The layer is made of a material or has a coating that is UV resistant. This element holds all the other layers together and protects young saplings and their roots from UV and protects the skin for mechanical damages during shipping and installation.

The growth media 30 forming part of the component 26 can be made from various substrates and other materials generically suitable for various plants, including trees, flowers, grasses, and other plants. However in a preferred embodiment, the growth media 30 within the component 26 is selected for particular plants and/or specific climates and water retaining levels. Some illustrative compositions for growth media are provided below:

a. Versatile media generically suitable for various plants includes 25% of a mixture of perlite, pumice, xeolite, lava, crushed bricks (referred to herein is a hydromix) and 75% a blend of frozen black sphagnum peat and sphagnum peat (referred to in the trade as potting soil or potting substrate).

b. For semi-aquatic plants the media may consist of 100% potting substrate.

c. For mild drought resisting plants the media may consist of about 50% hydromix and 50% potting substrate;

d. For hardy, drought resistant plants, the media may include about 80% hydromix and 20% potting substrate (all by volume).

Preferably the skin 20 is manufactured as follows. The various components are disposed on top of each other in elongated strips, each strip being up to several hundred feet long and wide enough to form one or more rows disposed vertically in a spaced relationship as shown in FIG. 2. The components are sewn together. In a preferred embodiment, nylon thread used for fishing may be used in this process. The sleeve 28 may be filled with the growth media before, or after the components are sewn together, or alternatively, the sleeve 28 may be left empty initially and then filled with media either at the site, or after at least the type of media required becomes known.

The thus formed skin 20 is then transported to the site, First the water source 18 (and other auxiliary equipment, such as a return pipe 40, and various other sensors, switches, valves, etc.) are installed. The skin 20 is then installed in several rows 20A, 20B, 20C by using stainless steel staples or any other known means to secure the skin 20 to the member 16 and, optionally, to member 14. As can be seen in FIG. 2, the layers 22, 24, 32, 34 can be made somewhat wider so that they can overlap water source 18 and hide it from view. The skins can be arranged at a suitable lateral spacing from each other. A typical spacing may be about 2″. The wall on which the installation is attached should be fairly straight and even, although the installation can be mounted in segments as well to follow the shapes and contours of the supporting wall. Moreover, the wall can also be slanted from vertical.

In addition, the shape of component 26, allows for birds to build bird nests 50 easily, and/or bee nests 52 thereby creating a microecology in the plantation installation.

The plantation installation of FIGS. 1 and 2 is used as follows. The installation is assembled and attached to the external member 12 as discussed above and shown in the drawings. The skin rows 20 are then watered either externally or through water source 18 and a plurality of plants of one or more different varieties are planted into the skins. More specifically, a suitable slit (not shown) is made with a knife in an upper portion of the layers 26, 30, 32 and the root of each of the plants 60 is pushed through the slits into the media 30. The various components are supple to form a supporting frame around each plant and support it in place originally. Once the plants 60 grow respective root systems, they are supported by these root systems in the conventional manner. The water source 18 is activated so that it provides water and, optionally, nutrients to the plants at regular intervals and/or based on demand as indicated by sensors (not shown). If there are many rows of skin 20 provided at a given installation, several water sources 18 may be provided. Excess water may be captured at the bottom by a return tray 40 and returned to a tank (after suitable filtration) and recycled. Moreover, the tank may be using gray water from the building thereby further insuring that no clean resources are wasted by the installation. Preferably, as clearly shown in FIG. 2, at least some of the components, such as layers 22, 32 and 34 extend over the water sources 18

In an alternate embodiment, instead of young plants, or saplings, seeds are implanted into the media 30.

In yet another embodiment, seeds 62 are pre-planted into the skin (e.g., the media and/or layers 32, 34 before the skin is installed on the vertical wall.

Overall the hydroponic skin 20 has a weight of 8 kg/square meter has a higher water retention (15 liters per square meter) and higher substrate volume then previous plantation installation. This structure insures that it has a better performance at high ambient temperatures, requiring less water (thus functioning even if local laws prohibit daily watering), allowing better drainage for plants, more space for roots spreading, facilitating the growth of bigger plants and trees, providing more thermal and acoustic insulation for the supportive building and reducing its carbon footprint.

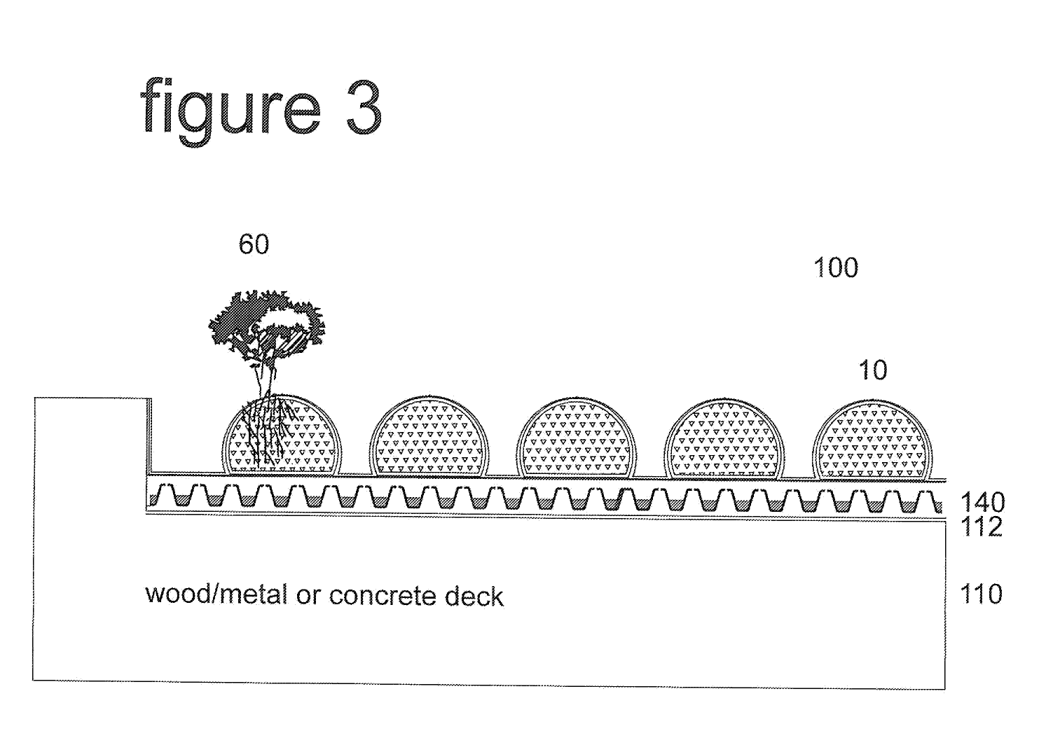

As previously mentioned the skin 20 can be used for vertical plantation installations and other types of installations as well. FIG. 3 shows a horizontal plantation installation 100. In this embodiment, the installation 100 is supported on a flat deck 110. Deck 110 may be any relatively horizontal surface adjacent to a structure or could be the roof of a building. The deck 110 is covered with a membrane 112 that provides water proofing to protect the deck 110 from any liquids. On top of the membrane there are one or more channels 140 provided to trap and collect liquids dripping down from the installation. The channels 140 could be trays that are abutting each other to maximize the amount of liquids being collected and minimize the amount of liquids that fall onto the membrane 110. The skin 10 is then disposed on top of the channels 140 and arranged to receive plants 60. While in FIG. 3 the deck 110 is horizontal, it can be slanted by up to about 35 degrees. In the case the deck 110 is slanted, the skin can be supported by aluminum lateral bars. Water and nutrients are provided to the plantation installation using standard sprinkler systems (not shown).

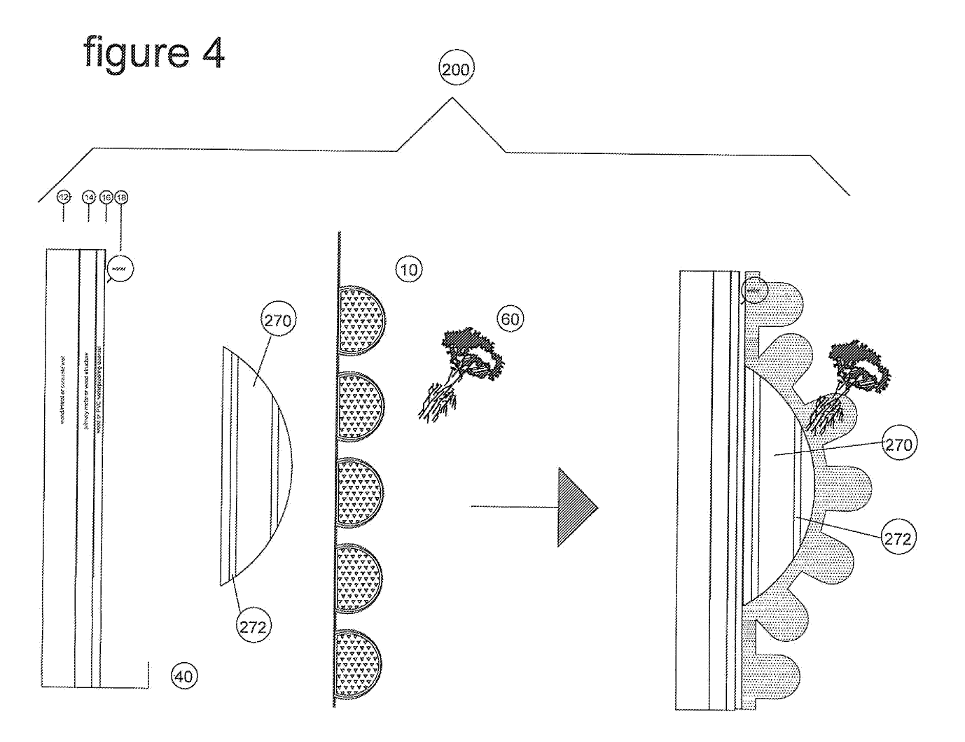

FIG. 4 shows another embodiment of the invention. This embodiment presents a plantation installation 200 which is shaped in three dimensions to provide a more complex and visually pleasing effect. The same components are used as in the embodiment of FIGS. 1 and 2, however a filler component 270 is provided between the substrate 16 and the skin 10. The skin 10 is somewhat flexible so that once it is attached to the components 14, 16, it fits around, and follows the contours of the filler component 270. Preferably, the component 270 is provided with channels 272 that provide paths for water to the lower parts of component 270 and therefore from the source 18 to flow to the various parts of the skin 10 thereby providing water and nutrients to the plants.

The filler component 270 can have various shapes. For example, it could be hemispherical, ovoidal(egg shaped) and so on. Using different shaped filler components, the plantation installation can have numerous 3-D shapes.

Numerous modifications may be made to the invention without departing from its scope as defined in the appended claims.

We claim:

1. A plantation installation for forming a living wall on an external architectural member having generally a vertically oriented outer surface, the planting installation comprising:
a water proof layer attached to said outer surface; and
a plant support structure disposed outwardly of said architectural member and said water proof layer, said plant support structure including a tubular component made of a first water retaining material and defining a tubular inner space, growth media disposed in said tubular inner space, said growth media including materials selected to provide water and nourishment to plants; a first protective layer disposed outside and around said tubular component, said first protective layer being made of a second water retentive material, and a second protective layer disposed around said first protective layer.

2. The installation of claim 1 wherein said growth media is selected from one of a hydromix, a potting substrate and a mixture of hydromix and potting mix.

3. The installation of claim 2 wherein said plantation installation includes a plurality of plants and said growth media is selected to provide appropriate water and nutrient specific to said plurality of plants.

4. The installation of claim 1 wherein said growth media consists of potting substrate.

5. The installation of claim 1 wherein said growth media consists of hydromix.

6. The installation of claim 1 further comprising another layer disposed between said water proof layer and said plant support structure, said another layer being made of a water retaining material.

7. The installation of claim 1 further comprising a water pipe extending horizontally above said plant support structure, said water pipe being arranged to provide water to said plant support structure.

8. The installation of claim 1 wherein some layers of said plant support structure extend over and cover said water pipe.

9. A plantation installation providing a living wall on a flat architectural surface, said plantation installation comprising:
a water proof layer attached to the flat architectural surface and arranged to protected the flat architectural installation from water, said water proof layer being generally flat;
a first water retaining layer attached to said water proof layer, said first water retaining layer being generally flat;
a plurality of tubular components disposed generally in parallel to each other and disposed on said first water retaining layer, said growth media components holding a growth media selected to support and grow a plurality of plants;
a second water retaining layer made of water retaining material, said second water retaining layer including a tubular section wrapped at least partially around one of said tubular components; and
a protective layer disposed over said second water retaining layer and being made of a fabric selected to hold and support said tubular components and saud second water retaining layer together,

10. The plantation installation of claim 9 wherein said layers and components are oriented generally vertically.

11. The plantation installation of claim 9 wherein said layers and components are oriented generally horizontally.

12. The plantation installation of claim 9 wherein said layers and components are oriented generally along respective planes disposed at an angle of between 0 and 35 degrees with respect to a horizontal plane.

13. The plantation installation of claim 9 further including a filler component disposed underneath said second water retaining component and selected to provide a predetermined three dimensional shape for said plantation installation.

14. The plantation installation of claim 9 wherein said growth media includes a htydromix including at least one of perlite, pumice, xeolite, lava, crushed bricks.

15. The plantation installation of claim 9 wherein said growth media includes a potting substrate including at least one of frozen black sphagnum peat and sphagnum peat.

16. The plantation installation of claim 9 wherein said growth media includes a mixture of hydromix and potting substrate.

17. The plantation installation of claim 9 wherein said tubular components have a round cross section.

18. The plantation installation of claim 9 wherein said tubular components have a D-shaped cross section.

19. The plantation installation of claim 9 wherein said tubular components have an ovoidal cross section.

20. The plantation installation of claim 9 wherein further comprising a pipe extending horizontally, said pipe being arranged and constructed to provide at least one of water and nutrients to said growth media.
